(19) United States
(12) Patent Application Publication
(10) Pub. No.: US 2026/0270184 A1
(43) Pub. Date: Sep. 10, 2026

(54) METHOD AND DEVICE FOR IDENTIFYING ID-SPECIFIC FUNCTIONS OF VEHICLE COMMUNICATION PROTOCOL

(71) Applicant: KOOKMIN UNIVERSITY INDUSTRY ACADEMY COOPERATION FOUNDATION, Seoul (KR)

(72) Inventors: Sang Hoon JEON, Suwon-si (KR); Sang Min PARK, Namyangju-si (KR)

(21) Appl. No.: 19/655,601

(22) Filed: Apr. 22, 2026

Related U.S. Application Data
(63) Continuation of application No. PCT/KR2024/016395, filed on Oct. 25, 2024.

(30) Foreign Application Priority Data
Oct. 25, 2023 (KR) 10-2023-0143542

(51) Int. Cl. H04L 43/18; H04L 41/147; H04L 67/12

(52) U.S. Cl. CPC H04L 43/18; H04L 41/147; H04L 67/12

(57) ABSTRACT

Provided is a method for identifying a function for each ID of a vehicle communication protocol, which is performed by an electronic device. The present method for identifying a function for each ID comprises the steps of: classifying collected vehicle communication protocol data by ID; generating an ID-specific signal on the basis of the vehicle communication protocol data classified by ID; extracting an ID-specific feature on the basis of the vehicle communication protocol data classified by ID and the ID-specific signal; and on the basis of the extracted ID-specific feature, predicting functions respectively corresponding to IDs included in the vehicle communication protocol data.

### DESCRIPTION

### Technical Field

The present disclosure relates to an electronic device and a method for identifying ID-specific functions of a vehicle communication protocol performed by the electronic device.

### Background Art

Most cybersecurity issues within a vehicle exploit vehicle communication protocols such as Controller Area Network (CAN) or CAN with Flexible Data rate (CAN-FD). To appropriately defend against cyberattacks on a vehicle, it is necessary to know the functions corresponding to IDs included in messages of vehicle communication protocols.

However, ID-specific functions of a vehicle communication protocol are not standardized due to security issues and the like, and which ID is responsible for which function of a vehicle may vary for each vehicle manufacturer, or even for the same manufacturer, depending on the vehicle model or vehicle year.

Due to such characteristics of vehicle communication protocols, it is difficult to identify which function an ID is responsible for in a target vehicle to be analyzed, resulting in limitations in analyzing vehicle communication protocol data. For example, even when only a desired function is executed in a vehicle to collect data on a specific function, the collected data includes not only data of an ID responsible for the desired function but also data that occurs fundamentally or periodically in the vehicle. That is, the collected data includes data of various IDs other than the ID intended to be collected, making it difficult to analyze data of a specific function to be analyzed.

Meanwhile, although public databases exist that provide analysis of functions responsible for IDs of vehicle communication protocols for each vehicle, such databases only contain information for specific vehicles, and databases are not constructed for all ID-specific responsible functions of a vehicle. Furthermore, there are cases where incorrect function information, which differs from the actual responsible function of a vehicle communication protocol ID, is analyzed.

In addition, conventional vehicle communication protocol ID analysis for each responsible function is performed in a heuristic manner, which leads to cases where a large amount of time is consumed and analysis is performed with incorrect information.

### DETAILED DESCRIPTION OF THE INVENTION

### Technical Problem

An object of the present disclosure is to provide an electronic device and a control method thereof capable of automatically predicting ID-specific functions of a vehicle communication protocol.

### Technical Solution

According to an embodiment of the present disclosure, a method for identifying ID-specific functions of a vehicle communication protocol performed by an electronic device includes classifying collected vehicle communication protocol data for each ID, generating ID-specific signals based on the vehicle communication protocol data classified for each ID, extracting ID-specific features based on the vehicle communication protocol data classified for each ID and the ID-specific signals, and predicting functions respectively corresponding to IDs included in the vehicle communication protocol data based on the extracted ID-specific features.

In addition, the vehicle communication protocol data may include at least one of Controller Area Network (CAN) and CAN with Flexible Data rate (CAN-FD).

In addition, the vehicle communication protocol data may include at least one of vehicle communication protocol data occurring in a vehicle in a stationary state and vehicle communication protocol data occurring in a vehicle in an operating state.

In addition, the generating of the ID-specific signals may include extracting the ID-specific signals in units of a preset time interval from the vehicle communication protocol data classified for each ID.

In addition, the ID-specific features may include at least one of a similarity distance between IDs, a bit flip rate for each ID, and a bit histogram for each ID.

In addition, the extracting of the ID-specific features may include extracting at least one of the bit flip rate for each ID and the bit histogram for each ID from the vehicle communication protocol data classified for each ID, and extracting the similarity distance between IDs based on the ID-specific signals.

In addition, the similarity distance between the IDs may include a Dynamic Time Warping (DTW) distance between different ID signals.

In addition, the predicting of the functions respectively corresponding to the IDs may include inputting the extracted ID-specific features into an artificial intelligence model trained to predict a function corresponding to an ID.

In addition, the artificial intelligence model may be a model trained based on vehicle communication protocol data collected from the same vehicle as the vehicle from which the vehicle communication protocol data is collected.

In addition, the artificial intelligence model may be a model trained based on vehicle communication protocol data collected from a vehicle different from the vehicle from which the vehicle communication protocol data is collected.

In addition, the method may include training an artificial intelligence model based on the extracted ID-specific features.

In addition, the training of the artificial intelligence model may include training the artificial intelligence model to predict a function corresponding to an ID based on the extracted ID-specific features and ID-specific function information, and the ID-specific function information may be obtained from a vehicle communication protocol database including information on functions corresponding to the IDs.

Meanwhile, an electronic device according to an embodiment of the present disclosure includes a memory for storing collected vehicle communication protocol data, and a processor that classifies the collected vehicle communication protocol data for each ID, generates ID-specific signals based on the vehicle communication protocol data classified for each ID, extracts ID-specific features based on the vehicle communication protocol data classified for each ID and the ID-specific signals, and predicts functions respectively corresponding to the IDs included in the vehicle communication protocol data based on the extracted ID-specific features.

In addition, the processor may extract the ID-specific signals in units of a preset time interval from the vehicle communication protocol data classified for each ID.

In addition, the ID-specific features may include at least one of a similarity distance between the IDs, a bit flip rate for each ID, and a bit histogram for each ID.

In addition, the processor may extract at least one of the bit flip rate for each ID and the bit histogram for each ID from the vehicle communication protocol data classified for each ID, and may extract the similarity distance between the IDs based on the ID-specific signals.

In addition, the similarity distance between the IDs may include a Dynamic Time Warping (DTW) distance between different ID signals.

In addition, the memory may store an artificial intelligence model trained to predict a function corresponding to the ID, and the processor may predict functions respectively corresponding to the IDs included in the vehicle communication protocol data by inputting the extracted ID-specific features into the artificial intelligence model.

In addition, the processor may train the artificial intelligence model based on the extracted ID-specific features.

Meanwhile, in a non-transitory computer-readable recording medium storing computer instructions that, when executed by a processor of an electronic device, cause the electronic device to perform operations according to an embodiment of the present disclosure, the operations may include classifying collected vehicle communication protocol data for each ID, generating ID-specific signals based on the vehicle communication protocol data classified for each ID, extracting ID-specific features based on the vehicle communication protocol data classified for each ID and the ID-specific signals, and predicting functions respectively corresponding to IDs included in the vehicle communication protocol data based on the extracted ID-specific features.

### Advantageous Effects Of The Invention

According to various embodiments of the present disclosure described above, ID-specific functions of a vehicle communication protocol may be automatically predicted rapidly and accurately.

### DESCRIPTION OF THE DRAWINGS

FIG. 1 is a block diagram illustrating a Controller Area Network (CAN) communication system according to an embodiment of the present disclosure.

FIG. 2 is a diagram for describing a CAN message format according to an embodiment of the present disclosure.

FIG. 3 is a block diagram of an electronic device according to an embodiment of the present disclosure.

FIG. 4 is a diagram for describing a configuration and an operation of a processor according to an embodiment of the present disclosure.

FIG. 5 is a diagram for describing training data according to an embodiment of the present disclosure.

FIG. 6 is a diagram for describing training data according to an embodiment of the present disclosure.

FIG. 7 is a block diagram of an electronic device according to an embodiment of the present disclosure.

FIG. 8 is a flowchart illustrating an operation method of an electronic device according to an embodiment of the present disclosure.

FIG. 9 is a flowchart illustrating an operation method of an electronic device according to an embodiment of the present disclosure.

FIG. 10 is a flowchart illustrating an operation method of an electronic device according to an embodiment of the present disclosure.

### BEST MODE

Various embodiments of the present disclosure described below with reference to the drawings are not intended to limit the scope to specific embodiments, and should be understood to include various modifications, equivalents, and/or alternatives. In connection with the description of the drawings, similar reference numerals may be used for similar components.

In describing the present disclosure, when it is determined that a detailed description of related known technologies may unnecessarily obscure the gist of the present disclosure, the detailed description thereof will be omitted. In addition, redundant descriptions of the same configuration will be omitted as much as possible.

The suffix “unit” for components used in the following description is given or used interchangeably only for the convenience of writing the specification, and does not itself have a distinct meaning or role.

The terms used in the present disclosure are used to describe embodiments and are not intended to limit and/or restrict the present disclosure. Singular expressions include plural expressions unless the context clearly dictates otherwise.

In the present disclosure, terms such as “include” or “have” are intended to designate that a feature, number, step, operation, component, part, or combination thereof described in the specification exists, and it should be understood that it does not preclude in advance the existence or addition of one or more other features, numbers, steps, operations, components, parts, or combinations thereof.

When it is mentioned that a certain component (e.g., a first component) is “(operatively or communicatively) coupled with/to” or “connected to” another component (e.g., a second component), it should be understood that the certain component may be directly connected to the other component or may be connected through another component (e.g., a third component). On the other hand, when it is mentioned that a certain component (e.g., a first component) is “directly connected to” or “directly coupled to” another component (e.g., a second component), it may be understood that no other component (e.g., a third component) exists between the certain component and the other component.

Terms used in the embodiments of the present disclosure may be interpreted as meanings commonly known to those of ordinary skill in the art unless otherwise defined.

Hereinafter, various embodiments of the present disclosure will be described in detail with reference to the accompanying drawings.

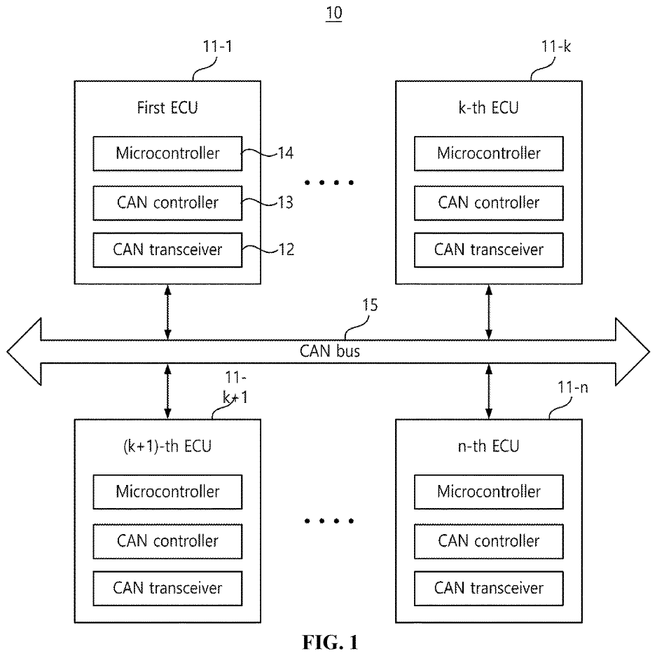

FIG. 1 is a block diagram illustrating a Controller Area Network (CAN) communication system according to an embodiment of the present disclosure.

Referring to FIG. 1, a CAN communication system 10 may include a CAN bus 15 for transmitting and receiving data, and a plurality of Electronic Control Units (ECUs) (11-1 to 11-n) connected to the CAN bus 15.

The CAN bus 15 is a communication line for data transmission and may be composed of, for example, optical fibers or a twisted pair wire. In this case, the two wires constituting the twisted pair wire may be driven by different signals (CAN_H and CAN_L).

The ECUs (Electronic Control Units) (11-1 to 11-n) may be various electronic control devices included in a vehicle. For example, the ECUs (11-1 to 11-n) may include ECUs related to telematics or navigation systems, ECUs related to a powertrain such as an engine device or a transmission device, ECUs related to a chassis such as a braking device, a steering device, or an airbag device, and ECUs related to a body such as a cluster, a door, or a window. In detail, the ECUs (11-1 to 11-n) may include ECUs related to all electronically controlled functions of a vehicle, such as a smart key, a digital dashboard, an ABS brake, headlights, an air conditioner, engine control, and cruise control.

Each ECU (11-1 to 11-n) may be connected to the CAN bus 15 through a predetermined CAN connector and may transmit and receive data using a CAN protocol.

Meanwhile, each ECU (11-1 to 11-n) may include a CAN transceiver 12, a CAN controller 13, and a microcontroller (CPU) 14.

The CAN transceiver 12 is connected to the CAN bus 15 through a predetermined CAN connector and may constitute a physical layer of the ECU. The CAN transceiver 12 may provide a function of detecting and managing a failure of the CAN bus 15 and a function of transmitting and receiving messages.

The CAN controller 13 may transmit and receive CAN protocol messages and may perform a message filtering function for the received messages. In addition, the CAN controller 13 may provide a message buffer function for retransmission control and an interface function with the microcontroller 14.

The microcontroller 14 may include a CPU, and may provide a higher layer protocol and various applications for performing functions of the corresponding ECU.

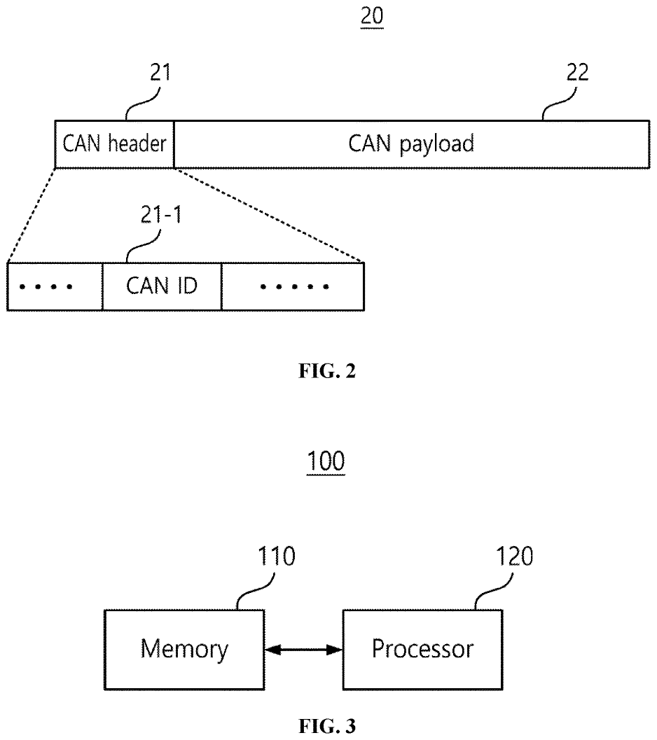

FIG. 2 is a diagram for describing a CAN message format according to an embodiment of the present disclosure. For example, each ECU (11-1 to 11-n) of FIG. 1 may transmit and receive a CAN message 20 in a format as illustrated in FIG. 2 through the CAN bus 15.

Referring to FIG. 2, the CAN message may include a CAN header 21 and a CAN payload 22, which is a data frame part. The specification of the CAN message may follow the specification defined by the CAN protocol.

Information that the corresponding ECU intends to transmit may be recorded in the CAN payload 22. For example, when the ECU is an engine ECU, data on the current state of the engine may be recorded in a field of the CAN payload 22.

A CAN ID 21-1 field in which an ID of the corresponding message is recorded may be included in the CAN header 21. In this case, the ID is an identifier of the corresponding message and may indicate the type of the message. For example, messages containing RPM information of an engine are periodically transmitted from an ECU related to engine control to the CAN bus 15, and all corresponding messages may have the same CAN ID. That is, the CAN ID may correspond to a specific function of the corresponding vehicle. Meanwhile, an ECU receiving a message may check which function the corresponding message includes data related to through the ID recorded in the message CAN ID 21-1 field.

In FIGS. 1 and 2, CAN is described as an example of a vehicle communication protocol, but the embodiment is not limited thereto. In the present disclosure, the vehicle communication protocol may include Extended CAN and CAN with Flexible Data-Rate (CAN-FD).

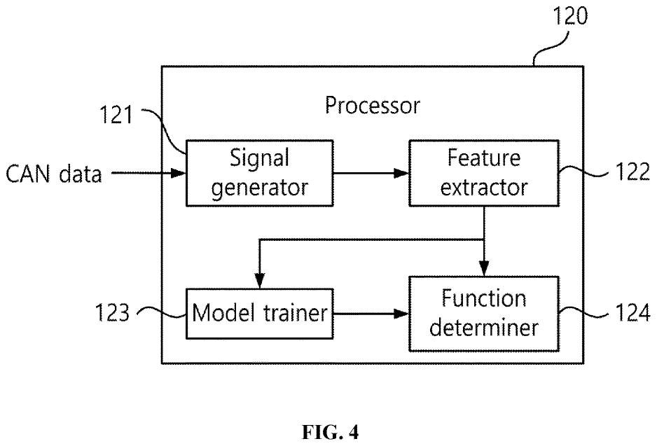

FIG. 3 is a block diagram illustrating a configuration of an electronic device according to an embodiment of the present disclosure. For example, an electronic device 100 may be implemented as various computing devices such as a notebook, a tablet computer, a PC, a server device, a workstation, etc., but is not limited thereto.

Referring to FIG. 3, the electronic device 100 may include a memory 110 and a processor 120. The memory 110 may store various programs and data for controlling the operation of the electronic device 100.

In particular, according to an embodiment of the present disclosure, the memory 110 may store collected vehicle communication protocol data. For example, CAN data transmitted and received through the CAN bus 15 for a predetermined period in a vehicle including the CAN communication system 10 of FIG. 1 may be collected by a user, and the user may store the collected CAN data in the memory 110 of the electronic device 100.

According to an embodiment, CAN data occurring during a predetermined period in a vehicle in a stationary state may be collected and stored in the memory 110. In addition, CAN data occurring during a predetermined period in a vehicle in an operating state may be collected and stored in the memory 110. The collected CAN data stored in the memory 110 may be processed by the processor 120, as will be described later, and used to predict functions for each CAN ID.

Meanwhile, the collected vehicle communication protocol data is not limited to CAN data, and according to embodiments, CAN-FD data may be collected and stored in the memory 110 and used for predicting functions for each ID.

The processor 120 may control the overall operation of the electronic device 100. The processor 120 may be composed of one or more cores. The processor 120 may include at least one of a central processing unit (CPU), a general-purpose graphics processing unit (GPGPU), an application processor (AP), a communication processor (CP), or a tensor processing unit (TPU), and may perform operations of the electronic device 100 according to various embodiments of the present disclosure by executing programs stored in the memory 110.

In particular, the processor 120 may classify the collected vehicle communication protocol data stored in the memory 110 for each ID. The vehicle communication protocol data collected during a predetermined period may include numerous messages corresponding to various functions of the vehicle operating during the corresponding period. The processor 120 may classify these numerous messages for each ID.

In addition, the processor 120 may generate ID-specific signals based on the vehicle communication protocol data classified for each ID. According to an embodiment, the processor 120 may extract the ID-specific signals in units of a preset time interval from the vehicle communication protocol data classified for each ID. For example, the processor 120 may extract the ID-specific signals in units of 100 ms, 200 ms, 300 ms, 500 ms, or 1 s, but is not limited thereto. Accordingly, the processor 120 may extract the ID-specific signals as signals of various frequency bands.

In addition, the processor 120 may extract ID-specific features based on the vehicle communication protocol data classified for each ID and the ID-specific signals. In this case, the ID-specific features may include at least one of a similarity distance between IDs, a bit flip rate for each ID, and a bit histogram for each ID.

According to an embodiment, the processor 120 may extract at least one of the bit flip rate for each ID and the bit histogram for each ID from the vehicle communication protocol data classified for each ID. In addition, the processor 120 may extract a similarity distance between the IDs based on the ID-specific signals. Here, the similarity distance between the IDs may include a Dynamic Time Warping (DTW) distance between different ID signals.

The Euclidean distance, which is generally used when measuring similarity between two signals, measures the similarity (i.e., distance) between two signals on the same timeline, and thus has disadvantages in that it is difficult to find similarity as the shaking and movement of signals become severe, and the distance cannot be measured for time series of different lengths.

In contrast, the DTW distance measures the similarity between two signals by finding a warping path that minimizes the cumulative distance by matching in a direction where the distance is minimized, and thus may measure the similarity between two signals with different movements according to speed or length. That is, when using the DTW distance, the limitations of Euclidean distance measurement may be resolved.

The aforementioned ID-specific signals may have different starting points, ending points, and lengths for each signal. Therefore, according to an embodiment of the present disclosure, the processor 120 may calculate a DTW distance between different ID signals and use it as an ID-specific feature. Accordingly, the similarity distance between IDs may be used as a feature for predicting a function corresponding to the ID.

The closer the DTW distance between two ID signals is, the more likely the corresponding ID signals have similar waveforms. Having similar waveforms for ID signals may mean that messages of each ID occurred at a similar frequency during the same time interval. Since the IDs occurring at a similar frequency during a specific time interval may be interpreted as the IDs having similar characteristics (or functions), the DTW distance between ID-specific signals may be used as a feature for predicting ID-specific functions.

For example, a signal with CAN ID 130 and a signal with CAN ID 140 have a very close DTW distance and have similar waveforms. According to public information, it may be seen that both CAN IDs 130 and 140 are actually IDs related to a Yaw Rate Sensor (YRS) that detects torsion of a vehicle in an Electronic Stability System (ESP). Therefore, for example, when known function information exists for a first ID and public function information does not exist for a second ID, when the DTW distance between the first ID signal and the second ID signal is close, it may be determined that the second ID is also an ID responsible for a function similar to the first ID in the vehicle.

Meanwhile, the processor 120 may predict functions respectively corresponding to the IDs included in the vehicle communication protocol data based on the extracted ID-specific features. For example, the processor 120 may predict (or infer) functions respectively corresponding to the IDs by inputting the extracted ID-specific features into an artificial intelligence model trained to predict a function corresponding to the ID.

According to an embodiment, the processor 120 may train an artificial intelligence model to predict a function corresponding to the ID. For example, the memory 110 may store vehicle communication protocol data for training and ID-specific function information. Here, the ID-specific function information is information in which a function corresponding to the ID is matched, and may be a type of target (or label) for training the artificial intelligence model. In this case, the ID-specific function information may be information obtained from a public vehicle communication protocol database including function information corresponding to the IDs, but is not limited thereto. Meanwhile, the processor 120 may extract the aforementioned ID-specific features from the vehicle communication protocol data for training. In this case, the extracted ID-specific features may be a type of feature for training the artificial intelligence model. Accordingly, the processor 120 may train the artificial intelligence model to predict a function corresponding to the ID by using the ID-specific features extracted from the vehicle communication protocol data for training and the ID-specific function information. The processor 120 may predict functions respectively corresponding to the IDs included in the collected vehicle communication protocol data using the artificial intelligence model trained in this way.

In the above, an example in which the processor 120 trains an artificial intelligence model to predict a function corresponding to the ID is described, but embodiments are not limited thereto. For example, the artificial intelligence model may be trained in another electronic device to predict a function corresponding to the ID, and the artificial intelligence model trained in this way may be stored in the memory 110. In this case, the processor 120 may predict functions respectively corresponding to the IDs included in the collected vehicle communication protocol data by using the trained artificial intelligence model stored in the memory 110.

According to various embodiments of the present disclosure described above, ID-specific functions of a vehicle communication protocol may be automatically predicted rapidly and accurately.

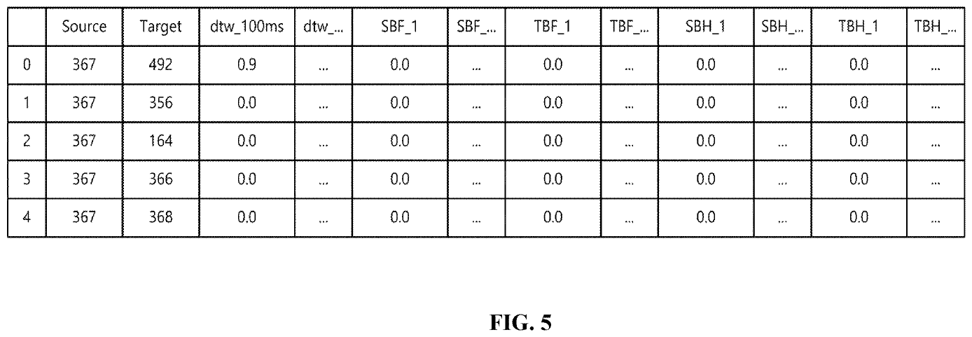

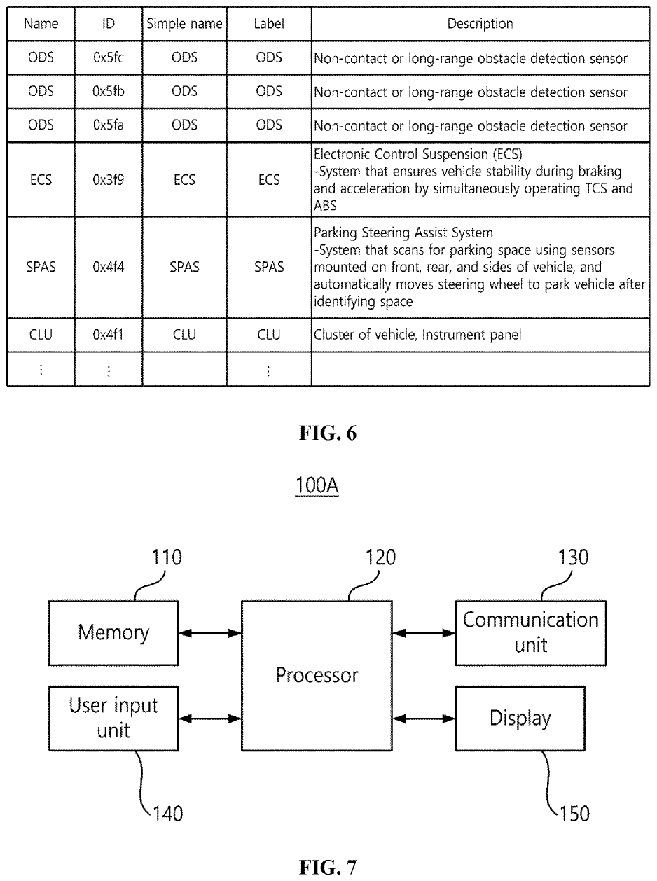

Hereinafter, the configuration and operation of a processor according to an embodiment of the present disclosure will be described with reference to FIGS. 4 to 6. FIG. 4 is a diagram illustrating a configuration of a processor according to an embodiment of the present disclosure, and FIGS. 5 and 6 are diagrams illustrating training data according to an embodiment of the present disclosure.

Referring to FIG. 4, the processor 120 may include a signal generator 121, a feature extractor 122, a model trainer 123, and a function determiner 124.

The signal generator 121 may generate ID-specific signals from CAN data. In detail, when the CAN data is input from the memory 110, the signal generator 121 may classify the CAN data for each ID and may generate ID-specific signals based on the CAN data classified for each ID. In this case, the signal generator 121 may generate the ID-specific signals by extracting the ID-specific signals in units of a preset time interval from the CAN data classified for each ID. The ID-specific signals of various frequency bands may be generated depending on the time period for extracting the signals.

The feature extractor 122 may extract features to be used in predicting the responsible function of the CAN ID from the ID-specific signals generated by the signal generator 121. For example, the feature extractor 122 may extract ID-specific features based on the CAN data classified for each ID and the ID-specific signals. In this case, the ID-specific features may include at least one of a similarity distance between the IDs, a bit flip rate for each ID, and a bit histogram for each ID. According to an embodiment, the feature extractor 122 may extract at least one of the bit flip rate for each ID and the bit histogram for each ID from the CAN data classified for each ID. In addition, the feature extractor 122 may extract a similarity distance between the IDs based on the ID-specific signals. In this case, the similarity distance between the IDs may include a DTW distance between different ID signals.

The function determiner 124 may predict functions respectively corresponding to the IDs included in the CAN data based on the extracted ID-specific features. For example, when an artificial intelligence model trained to predict a function corresponding to the ID exists in the memory 110, the function determiner 124 may predict functions respectively corresponding to the IDs included in the CAN data by inputting the extracted ID-specific features into the trained artificial intelligence model.

In this case, according to an embodiment, the trained artificial intelligence model may be a model trained based on CAN data collected from the same vehicle as the vehicle from which the CAN data, which is the subject of the responsible function analysis for each ID, is collected. Alternatively, according to an embodiment, the trained artificial intelligence model may be a model trained based on CAN data collected from a vehicle different from the vehicle from which the CAN data, which is the subject of the responsible function analysis for each ID, is collected.

The model trainer 123 may train the artificial intelligence model based on the extracted ID-specific features. For example, when CAN data for training is received, The ID-specific features for the CAN data for training may be extracted by the signal generator 121 and the feature extractor 122. The model trainer 123 may use the ID-specific features for the CAN data for training extracted in this way as features for training the artificial intelligence model. In this case, according to an embodiment, the model trainer 123 may pre-process the extracted ID-specific features into a form as illustrated in FIG. 5 or a graph form, etc., such that the extracted ID-specific features may be well reflected in the training. Referring to FIG. 5, the feature data for training may include a source, a target, a DTW distance, a source bit flip (SBF), a target bit flip (TBF), a source bit histogram (SBH), a target bit histogram (TBH), and the like. In this case, a signal having CAN ID 367 becomes a source, and signals of other CAN IDs may be targets. In addition, the DTW distance represents a DTW distance between the source and target signals. Although FIG. 5 illustrates DTW distances between source and target signals extracted in units of 100 ms, it is not limited thereto, and it is understood that DTW distances of the source and target calculated based on ID-specific signals extracted in units of 200 ms, 300 ms, 500 ms, or 1 s may be further used as feature data for training. Although FIG. 5 illustrates a case where the feature data for training includes all of the source, target, DTW distance, source bit flip (SBF), target bit flip (TBF), source bit histogram (SBH), and target bit histogram (TBH), embodiments are not limited thereto. For example, the feature data for training may include only the source, the target, and the DTW distance, or may further include the bit flip data or the bit histogram data of the source or the target according to embodiments.

Meanwhile, the model trainer 123 may use ID-specific function information as a target. In this case, the ID-specific function information may be obtained from a public CAN database including function information corresponding to the IDs, but is not limited thereto, and may be created experimentally or arbitrarily by a user. The ID-specific function information may be obtained or created in this way and may be stored in the memory 110. FIG. 6 illustrates an example of target data for training obtained from a public CAN database. Referring to FIG. 6, the target data for training may include CAN IDs and names, labels, and descriptions corresponding to each CAN ID, but is not limited thereto.

Accordingly, the model trainer 123 may train the artificial intelligence model to predict a function corresponding to the ID by using the ID-specific features and the ID-specific function information extracted from the CAN data for training.

Meanwhile, the artificial intelligence model trained by the model trainer 123 may include various neural network models such as an Artificial Neural Network (ANN), a Deep Neural Network (DNN), a Convolutional Neural Network (CNN), a Recurrent Neural Network (RNN), etc., but is not limited thereto.

The artificial intelligence model trained in the model trainer 123 may be used by the function determiner 124 to predict functions respectively corresponding to the IDs included in the CAN data.

Although FIGS. 4 to 6 illustrate a case where the data for prediction or the data for training is the CAN data, embodiments are not limited thereto, and it is understood that CAN-FD data may be used for ID-specific function prediction and artificial intelligence model training according to embodiments. In addition, although FIG. 4 illustrates an example in which the processor 120 includes both the model trainer 123 and the function determiner 124, embodiments are not limited thereto, and the processor 120 may include at least one of the model trainer 123 and the function determiner 124.

FIG. 7 is a block diagram illustrating an implementation example of an electronic device according to an embodiment of the present disclosure. FIG. 7 comprehensively illustrates various components that may be included in an electronic device 100A. Therefore, according to embodiments, some of the components illustrated in FIG. 7 may be omitted or changed, and other components may be further added. In describing FIG. 7, redundant descriptions of the same configurations as those of the electronic device 100 described above will be omitted or simplified.

Referring to FIG. 7, the electronic device 100A may include the memory 110, the processor 120, a communication unit 130, a user input unit 140, and a display 150.

The memory 110 may store an operating system (OS) for controlling the overall operation of the electronic device 100A. In addition, the memory 110 may store various algorithms, programs, data, etc., for performing various functions of the aforementioned electronic device 100. In particular, the memory 110 may store the aforementioned vehicle communication protocol data, artificial intelligence model, ID-specific function information, and the like.

To this end, the memory 110 may include a volatile memory such as a DRAM and an SRAM, and a non-volatile memory such as an EEPROM and a flash memory capable of maintaining information even in a power-off state. In addition, the memory 110 may include a hard disk drive (HDD), a solid state drive (SSD), or a memory card (e.g., SD card, memory stick) detachable from the electronic device 100.

The processor 120 controls the overall operation of the electronic device 100A. In particular, the processor 120 may perform various calculations and data processing to perform operations of the processor 120 according to the various embodiments of the present disclosure described above, and may control operations of other components.

To this end, the processor 120 may control hardware or software components connected to the processor 120 by driving an operating system or an application program, and may perform various data processing and calculations. In addition, the processor 120 may load and process commands or data received from at least one of the other components into the volatile memory and store various data in the non-volatile memory.

The communication unit 130 may communicate with various external devices according to various types of communication schemes. For example, the communication unit 130 may communicate with an external server storing a public database that provides analysis of functions responsible for the IDs of vehicle communication protocols for each vehicle. In addition, the communication unit 130 may communicate with an external server storing vehicle communication protocol data for training or analysis. Accordingly, the processor 120 may request and receive ID-specific function information or vehicle communication protocol data from the external server through the communication unit 130. In addition, the communication unit 130 may perform Internet communication.

To this end, the communication unit 130 may include a wired/wireless LAN communication module. In addition, the communication unit 130 may include a short-range wireless communication module (not illustrated) or a mobile communication module according to embodiments. Here, the short-range wireless communication module (not illustrated) refers to a communication module that performs wireless data communication with an electronic device located at a short distance, such as, for example, a Bluetooth module, a ZigBee module, an NFC (Near Field Communication) module, and the like. In addition, the mobile communication module refers to a communication module that performs communication by accessing a mobile communication network according to various mobile communication standards such as 3G (3rd Generation), 3GPP (3rd Generation Partnership Project), LTE (Long Term Evolution), and the like.

According to embodiments, the communication unit 130 may include a broadcast reception module, and may include at least one of wired communication modules (not illustrated) such as Universal Serial Bus (USB), IEEE (Institute of Electrical and Electronics Engineers) 1394, RS-232, and the like.

The user input unit 140 may receive various user commands such as a control command, a selection command, an input command, and the like. To this end, the user input unit 140 may include a keyboard, a button, a keypad, a touch pad, or a touch screen. Alternatively, the user input unit 140 may be implemented as an input/output port. In this case, the user input unit 140 may be referred to as an input/output interface. When the user input unit 140 is implemented as an input/output port, the input/output port may include High-Definition Multimedia Interface (HDMI), DisplayPort (DP), RGB, Digital Visual Interface (DVI), Universal Serial Bus (USB), Thunderbolt, an audio jack, a video jack, and the like. The user input unit 140 may be referred to as an input device, an input unit, an input module, etc., and when implemented as an input/output port, it may also be referred to as an input/output device, an input/output unit, an input/output module, etc.

The display 150 may display various visual information such as a still image, a video, a user interface (UI), an icon, etc., under the control of the processor 120. To this end, the display 150 may be implemented in various forms such as a Liquid Crystal Display (LCD) Panel, light emitting diode (LED), Organic Light Emitting Diodes (OLED), micro LED, and the like. In addition, the display 150 may be combined with a touch panel to be implemented in the form of a touch screen.

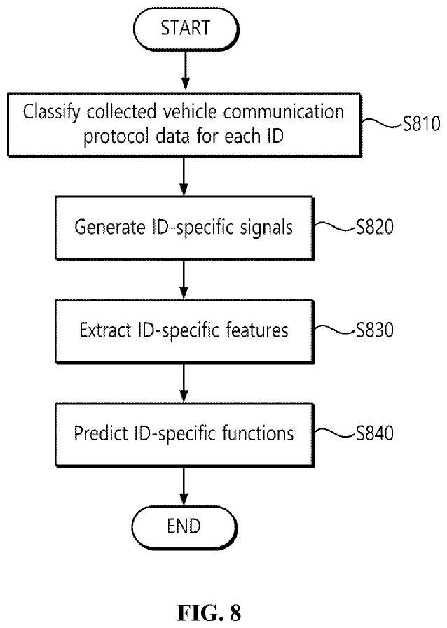

FIG. 8 is a flowchart illustrating an operation method of an electronic device according to an embodiment of the present disclosure. Referring to FIG. 8, in step S810, the electronic device (100 or 100A) may classify the collected vehicle communication protocol data for each ID. In this case, the vehicle communication protocol data may include at least one of CAN data and CAN-FD data. In addition, the vehicle communication protocol data may include at least one of vehicle communication protocol data occurring in a vehicle in a stationary state and vehicle communication protocol data occurring in a vehicle in an operating state.

In step S820, the electronic device (100 or 100A) may generate ID-specific signals based on the vehicle communication protocol data classified for each ID. For example, the electronic device (100 or 100A) may extract the ID-specific signals in units of a preset time interval from the vehicle communication protocol data classified for each ID.

In step S830, the electronic device (100 or 100A) may extract the ID-specific features based on the vehicle communication protocol data classified for each ID and the ID-specific signals. In this case, the ID-specific features may include a similarity distance between the IDs. In this case, the similarity distance between the IDs may include a DTW distance between different ID signals, but is not limited thereto. In addition, according to embodiments, the ID-specific features may further include at least one of a bit flip rate for each ID and a bit histogram for each ID, in addition to the similarity distance between the IDs. In this case, the electronic device (100 or 100A) may extract at least one of the bit flip rate for each ID and the bit histogram for each ID from the vehicle communication protocol data classified for each ID, and may extract the similarity distance between the IDs based on the ID-specific signals.

In step S840, the electronic device (100 or 100A) may predict or infer functions respectively corresponding to the IDs included in the vehicle communication protocol data based on the extracted ID-specific features. For example, the electronic device (100 or 100A) may predict or infer functions respectively corresponding to the IDs included in the vehicle communication protocol data using an artificial intelligence model trained to predict a function corresponding to the ID.

In this case, according to an embodiment, the artificial intelligence model may be a model trained based on vehicle communication protocol data collected from the same vehicle as the vehicle from which the vehicle communication protocol data is collected. Alternatively, the artificial intelligence model may be a model trained based on vehicle communication protocol data collected from a vehicle different from the vehicle from which the vehicle communication protocol data is collected.

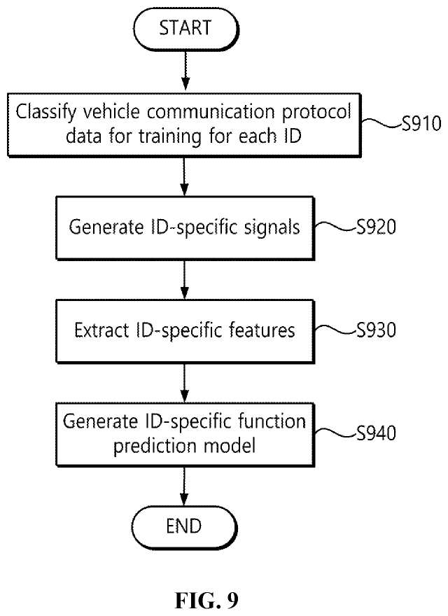

FIG. 9 is a flowchart illustrating an operation method of an electronic device according to an embodiment of the present disclosure. Referring to FIG. 9, in step S910, the electronic device (100 or 100A) may classify the vehicle communication protocol data for training for each ID.

In step S920, the electronic device (100 or 100A) may generate the ID-specific signals based on the vehicle communication protocol data classified for each ID. In addition, in step S930, the electronic device (100 or 100A) may extract the ID-specific features based on the vehicle communication protocol data classified for each ID and the ID-specific signals. The operations of the electronic device (100 or 100A) in steps S920 and S930 correspond to steps S820 and S830 of FIG. 8, and thus redundant descriptions are omitted.

In step S940, the electronic device (100 or 100A) may generate an ID-specific function prediction model. In detail, the electronic device (100 or 100A) may train the artificial intelligence model to predict a function corresponding to the ID based on ID-specific features and ID-specific function information extracted from the CAN data for training. In this case, the ID-specific function information may be obtained from a public CAN database including function information corresponding to the IDs, but is not limited thereto.

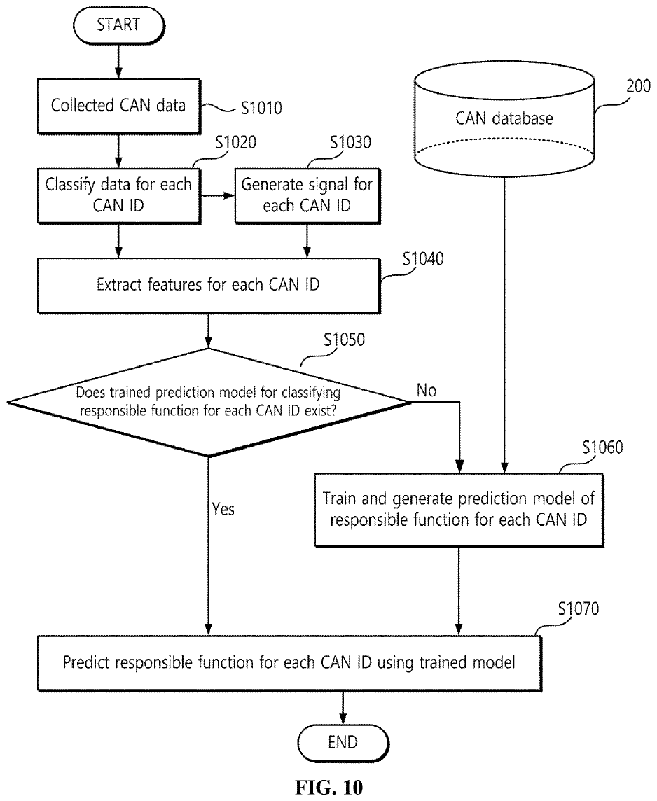

FIG. 10 is a flowchart illustrating an operation method of an electronic device according to an embodiment of the present disclosure.

In step S1010, the electronic device (100 or 100A) may receive the collected CAN data to be predicted through the user input unit 140. Accordingly, in step S1020, the electronic device (100 or 100A) may classify data for each CAN ID from the received CAN data. In addition, in step S1030, the electronic device (100 or 100A) may generate a signal for each CAN ID from the data classified for each CAN ID. In this case, the signal for each CAN ID may be generated by being extracted from the data classified for each CAN ID in units of a preset time interval such as 100 ms, 200 ms, 300 ms, etc., according to embodiments.

Meanwhile, in step S1040, the electronic device (100 or 100A) may extract features for each CAN ID. For example, the electronic device (100 or 100A) may extract features such as a bit flip rate or a bit histogram from the data classified for each CAN ID. In addition, the electronic device (100 or 100A) may extract similarity distance features between the IDs by calculating DTW distances for each signal for each CAN ID.

Accordingly, in step S1050, the electronic device (100 or 100A) determines whether a trained model for classifying a responsible function for each CAN ID exists, and when it exists (S1050, Yes), proceeds to step S1070 to predict the responsible function for each CAN ID using the trained model.

Meanwhile, in step S1050, if a trained model for classifying the responsible function for each CAN ID does not exist (S1050, No), the electronic device (100 or 100A) proceeds to step S1060 to receive CAN data for training from a CAN database 200, extract features to be used for responsible function prediction training for each CAN ID from the received CAN data for training, and then generate a responsible function prediction model for each CAN ID by training the model using the extracted features.

In the above description, embodiments are described in which the responsible function for each ID of the collected vehicle protocol data is predicted using an artificial intelligence model trained using the same vehicle communication protocol data as the collected vehicle communication protocol data. That is, in the above description, embodiments are described in which the responsible function for each ID of the collected CAN data is predicted using a model trained through the CAN data, or the responsible function for each ID of the collected CAN-FD data is predicted using a model trained through the CAN-FD data. However, embodiments are not limited thereto, and according to embodiments, the responsible function for each ID of the collected CAN-FD data may be predicted using a model trained through the CAN data, or vice versa.

According to various embodiments of the present disclosure as described above, ID-specific functions of a vehicle communication protocol may be automatically predicted rapidly and accurately.

In detail, by using an automated analysis tool rather than heuristic analysis for CAN IDs (or CAN-FD IDs) whose responsible functions are different for each vehicle manufacturer or vehicle model, not only analysis experts but also general users may quickly and accurately perform analysis of responsible functions for each CAN ID.

In addition, through analysis of responsible functions for each CAN ID (or CAN-FD ID), it is possible to easily determine whether the responsible functions of the vehicle are operating normally by generating a payload such that a desired function may operate in the vehicle. Accordingly, it is possible to quickly repair only the broken part.

In addition, at the present time when the importance of vehicle cybersecurity such as ISO 21434 is emphasized, various embodiments of the present disclosure described above may be utilized to strengthen security after identifying vulnerable parts through simulation hacking that malfunctions responsible functions using responsible functions for each CAN ID. In addition, it is possible to prevent accidents caused by unintended actions in advance by detecting and blocking abnormal behaviors occurring in the vehicle for each responsible function.

Meanwhile, various embodiments of the present disclosure may be implemented as software including instructions stored in a machine (e.g., a computer)-readable storage medium. Here, the machine is a device capable of calling stored instructions from a storage medium and operating according to the called instructions, and may include the electronic device (100 or 100A) according to the disclosed embodiments.

When the command is executed by a processor, the processor may perform a function corresponding to the command directly or using other components under the control of the processor. The command may include code generated or executed by a compiler or an interpreter. The machine-readable storage medium may be provided in the form of a non-transitory storage medium. Here, ‘non-transitory’ only means that the storage medium does not include a signal and is tangible, and does not distinguish that data is stored in the storage medium semi-permanently or temporarily.

According to an embodiment, methods according to various embodiments disclosed in the present disclosure may be provided included in a computer program product. The computer program product may be traded between a seller and a buyer as a product. The computer program product may be distributed online in the form of a machine-readable storage medium (e.g., compact disc read only memory (CD-ROM)) or through an application store (e.g., Play Store™). In the case of online distribution, at least a portion of the computer program product may be at least temporarily stored or temporarily generated in a storage medium such as a memory of a manufacturer's server, a server of an application store, or a relay server.

Each of the components (e.g., modules or programs) according to various embodiments may be composed of a single or a plurality of entities, and some of the aforementioned sub-components may be omitted, or other sub-components may be further included in various embodiments. Alternatively or additionally, some components (e.g., modules or programs) may be integrated into a single entity to perform functions performed by each corresponding component before integration identically or similarly. According to various embodiments, operations performed by a module, a program, or other components may be executed sequentially, in parallel, repeatedly, or heuristically, or at least some operations may be executed in a different order, omitted, or other operations may be added.

The above description is merely illustrative of the technical idea of the present disclosure, and various modifications and variations may be made by those of ordinary skill in the art without departing from the essential characteristics of the present disclosure. In addition, the embodiments according to the present disclosure are intended to describe rather than limit the technical idea of the present disclosure, and the scope of the technical idea of the present disclosure is not limited by these embodiments. Therefore, the scope of protection of the present disclosure should be interpreted by the following claims, and all technical ideas within the equivalent scope should be interpreted as being included in the scope of rights of the present disclosure.

1. A method for identifying ID-specific functions of a vehicle communication protocol performed by an electronic device, the method comprising:
classifying collected vehicle communication protocol data for each ID;
generating ID-specific signals based on the vehicle communication protocol data classified for each ID;
extracting ID-specific features based on the vehicle communication protocol data classified for each ID and the ID-specific signals; and
predicting functions respectively corresponding to IDs included in the vehicle communication protocol data based on the extracted ID-specific features.

2. The method of claim 1, wherein the vehicle communication protocol data includes at least one of Controller Area Network (CAN) data and CAN with Flexible Data rate (CAN-FD) data.

3. The method of claim 1, wherein the vehicle communication protocol data includes at least one of vehicle communication protocol data occurring in a vehicle in a stationary state and vehicle communication protocol data occurring in the vehicle in an operating state.

4. The method of claim 1, wherein the generating of the ID-specific signals includes extracting the ID-specific signals in units of a preset time interval from the vehicle communication protocol data classified for each ID.

5. The method of claim 1, wherein the ID-specific features include at least one of a similarity distance between the IDs, a bit flip rate for each ID, and a bit histogram for each ID.

6. The method of claim 5, wherein the extracting of the ID-specific features includes:
extracting at least one of the bit flip rate for each ID and the bit histogram for each ID from the vehicle communication protocol data classified for each ID; and
extracting the similarity distance between the IDs based on the ID-specific signals.

7. The method of claim 5, wherein the similarity distance between the IDs includes a Dynamic Time Warping (DTW) distance between different ID signals.

8. The method of claim 1, wherein the predicting of the functions respectively corresponding to the IDs includes inputting the extracted ID-specific features into an artificial intelligence model trained to predict the function corresponding to the ID.

9. The method of claim 8, wherein the artificial intelligence model is a model trained based on vehicle communication protocol data collected from the same vehicle as the vehicle from which the vehicle communication protocol data is collected.

10. The method of claim 8, wherein the artificial intelligence model is a model trained based on vehicle communication protocol data collected from a vehicle different from the vehicle from which the vehicle communication protocol data is collected.

11. The method of claim 1, further comprising: training an artificial intelligence model based on the extracted ID-specific features.

12. The method of claim 11, wherein the training of the artificial intelligence model includes training the artificial intelligence model to predict a function corresponding to the ID based on the extracted ID-specific features and ID-specific function information, and
wherein the ID-specific function information is obtained from a vehicle communication protocol database including information on the functions corresponding to the IDs.

13. An electronic device comprising:
a memory configured to store collected vehicle communication protocol data; and
a processor configured to: classify the collected vehicle communication protocol data for each ID; generate ID-specific signals based on the vehicle communication protocol data classified for each ID; extract ID-specific features based on the vehicle communication protocol data classified for each ID and the ID-specific signals; and predict functions respectively corresponding to IDs included in the vehicle communication protocol data based on the extracted ID-specific features.

14. The electronic device of claim 13, wherein the processor extracts the ID-specific signals in units of a preset time interval from the vehicle communication protocol data classified for each ID.

15. The electronic device of claim 13, wherein the ID-specific features include at least one of a similarity distance between the IDs, a bit flip rate for each ID, and a bit histogram for each ID.

16. The electronic device of claim 15, wherein the processor extracts at least one of the bit flip rate for each ID and the bit histogram for each ID from the vehicle communication protocol data classified for each ID, and extracts the similarity distance between the IDs based on the ID-specific signals.

17. The electronic device of claim 15, wherein the similarity distance between the IDs includes a Dynamic Time Warping (DTW) distance between different ID signals.

18. The electronic device of claim 13, wherein the memory stores an artificial intelligence model trained to predict a function corresponding to the ID; and
wherein the processor predicts the functions respectively corresponding to the IDs included in the vehicle communication protocol data by inputting the extracted ID-specific features into the artificial intelligence model.

19. The electronic device of claim 13, wherein the processor trains an artificial intelligence model based on the extracted ID-specific features.

20. A non-transitory computer-readable recording medium storing computer instructions that, when executed by a processor of an electronic device, cause the electronic device to perform operations comprising:
classifying collected vehicle communication protocol data for each ID;
generating ID-specific signals based on the vehicle communication protocol data classified for each ID;
extracting ID-specific features based on the vehicle communication protocol data classified for each ID and the ID-specific signals; and
predicting functions respectively corresponding to IDs included in the vehicle communication protocol data based on the extracted ID-specific features.
